(19) United States
(12) Patent Application Publication
(10) Pub. No.: US 2025/0138584 A1
(43) Pub. Date: May 1, 2025

(54) DISPLAY CART IN RETAIL STORES

(71) Applicant: CROSSMARK, INC., Lewisville, TX (US)

(72) Inventors: James Robert RENFROW, JR., Fayetteville, AR (US); Jeffrey Edward CHADD, Cave Springs, AR (US)

(21) Appl. No.: 18/933,747

(22) Filed: Oct. 31, 2024

Related U.S. Application Data
(60) Provisional application No. 63/595,294, filed on Nov. 1, 2023.

(51) Int. Cl. G06F 1/16; G06Q 30/0251

(52) U.S. Cl. CPC G06F 1/1637; G06Q 30/0268

(57) ABSTRACT

An assembly for display and storage, includes a main body with a top surface configured to present items, a bottom surface, and three side surfaces that define an internal cavity. The top surface may include at least one extendable platform that can transition between a stored position coplanar with the top surface and an open position extending laterally. Within the cavity, at least one height-adjustable shelf may be provided. The assembly may include a support that extends vertically from the main body, holding an adjustable signage assembly, which may be digital and remotely updatable.

### TECHNICAL FIELD

The present disclosure relates to storage and modular display carts.

### BACKGROUND

Portable display and storage assemblies are commonly used in retail, trade shows, and various promotional events to effectively present products, information, and branding materials in a compact, organized, and mobile manner. Traditional display units often consist of simple, fixed structures that lack versatility and functionality, making them inadequate for dynamic environments where frequent adjustments, mobility, or enhanced presentation options are required. These conventional assemblies also tend to offer limited customization, making it challenging for users to adapt the structure to different product types, display requirements, or spatial constraints.

### SUMMARY

In one configuration an assembly has a main body with a top surface, a bottom surface, and three side surfaces defining a cavity within the main body, wherein the top surface is configured to receive items for display, at least one shelf situated within the cavity of the main body, a support extendable in an upright direction from the main body, and a signage assembly adjustable above the main body held by the support. At least one of the side surfaces of the assembly may define a drawer opening configured to receive a drawer therethrough, the drawer configured to extend between a stored position within the cavity and an extended position at least partially outside of the cavity. The drawer may include a locking mechanism. The main body may be constructed from a metal alloy. The main body may be powder coated. The support may be telescopic. The signage assembly may be a digital signage assembly. The signage assembly may be a digital display configured to be updated remotely. The signage assembly may be interchangeable. The shelf may be adjustable in height within the cavity. The assembly may further include a set of wheels mounted on the bottom surface of the main body. The assembly may further include a cover to selectively enclose the cavity defined by the main body.

In another configuration an assembly has a main body with a top surface, a bottom surface, and three side surfaces defining a cavity within the main body, wherein the top surface includes at least one extendable platform selectively extendable between a stored position coplanar with the top surface and an open position extending laterally from the top surface, at least one shelf situated within the cavity of the main body, a support extendable in an upright direction from the main body, and a signage assembly adjustable above the main body held by the support. The at least one extendable platform may include two extendable platforms, each arranged at opposite side surfaces of the main body. The shelf may be adjustable in height within the cavity. The support may be telescopic. The signage assembly may be a digital signage. The at least one of the side surfaces may define an opening configured to receive a drawer therethrough, the drawer configured to extend between a stored position within the cavity and an extended position at least partially outside of the cavity. The drawer may include a locking mechanism.

In yet another configuration, an assembly has a main body with a top surface configured to receive items for display and including at least one extendable platform selectively extendable between a stored position coplanar with the top surface and an open position extending laterally from the top surface, a bottom surface, and three side surfaces defining a cavity within the main body, wherein at least one of the side surfaces defines a drawer opening configured to receive a drawer therethrough, at least one shelf adjustable in height situated within the cavity of the main body, a telescopic support extendable in an upright direction from the main body, an adjustable signage assembly above the main body held by the telescopic support, a drawer including a locking mechanism and configured to extend between a stored position within the cavity and an extended position at least partially outside of the cavity, a set of wheels mounted on the bottom surface of the main body for mobility, and a cover to selectively enclose the cavity defined by the main body.

### BRIEF DESCRIPTION OF THE DRAWINGS

FIGS. 1A and 1B are perspective views of a display assembly.

FIG. 2 is a side view of the display assembly of FIGS. 1A and 1B.

FIG. 3 is a rear view of the display assembly of FIGS. 1A and 1B.

FIG. 4 is an exploded view of the display assembly components of FIGS. 1A and 1B.

FIG. 5 is a perspective view of a display assembly with a cavity in the main body.

FIG. 6 is a front perspective view of the assembly of FIG. 5.

FIGS. 7 and 8 are perspective views of the display assembly of FIG. 5 with a drawer and extendable platform in open positions.

### DETAILED DESCRIPTION

While detailed embodiments of the present invention have been disclosed herein, it is to be understood that these embodiments are presented by way of example only and are not intended to limit the scope of the invention. The present invention is capable of numerous modifications, substitutions, and variations in form and function, as will be apparent to those skilled in the art. The specific configurations and figures described are provided to illustrate the principles of the invention and its practical applications, thereby enabling others skilled in the art to understand the invention for various embodiments with various modifications suited to the particular use contemplated.

The present disclosure relates to a versatile and multifunctional display cart assembly configured to enhance retail environments, particularly within grocery or retail stores and similar settings. This assembly may be engineered to address the dynamic needs of modern merchandising, combining aesthetics, functionality, and compliance with regulatory standards such as the Americans with Disabilities Act (ADA) as well as restrictions on alcohol sampling and display. The cart's minimal footprint ensures unobstructed movement within aisles, catering to both staff efficiency and customer accessibility.

A central component of the assembly is a robust main body constructed from durable materials, such as metal alloys, providing both structural integrity and longevity. The main body includes a top surface designed to be substantially planar and sturdy, serving as a primary platform for displaying a wide array of items, including food samples, beverages, promotional products, or interactive devices. The top surface's versatility allows retailers to adapt the display according to seasonal promotions, product launches, or customer engagement strategies.

Within the main body's cavity, at least one adjustable shelf is situated. This shelf's height adjustability may enable the accommodation of products of varying sizes and shapes. Whether showcasing tall bottles, boxed goods, or smaller packaged items, the adjustable shelf provides the flexibility needed for optimal product presentation and inventory management. Multiple shelves may be incorporated, each independently adjustable, to maximize storage capacity and organization.

Recognizing the necessity for secure storage, especially when handling sensitive or regulated items like alcoholic beverages, the assembly may include a strategically placed drawer accessible through an opening defined in one of the side surfaces. This drawer may be equipped with a robust locking mechanism, ensuring that contents remain secure and accessible only to authorized personnel. The locking drawer may comply with regulations concerning unattended access to alcohol, thereby mitigating inadvertent access while promoting responsible retail practices. Beyond alcohol storage, the drawer may house demonstration supplies, promotional materials, or valuable merchandise that requires protection.

Extending upward from the main body is an adjustable support structure, which may be telescopic in design. This support may be engineered to adjust in height smoothly, accommodating various display requirements and enhancing the visibility of promotional materials. Mounted atop this support is a signage assembly, which serves as a dynamic marketing tool. The signage assembly may be configured to be adjustable, interchangeable, and in some embodiments, digital. Digital signage capabilities may include displaying high-resolution images, videos, scrolling text, and interactive content, all of which may be updated remotely. This may allow for real-time promotional updates, targeted advertising, and the integration of multimedia elements to captivate customers.

The signage assembly may also incorporate advanced features such as QR codes, enabling customers to engage directly with digital content via their smartphones. Scanning the QR code may direct customers to detailed product information, virtual demonstrations, promotional offers, or even facilitate online purchases. This integration of physical and digital retail experiences may improve customer engagement and provide valuable data analytics for retailers.

The assembly's top surface further increases its functionality through the inclusion of at least one extendable platform. This platform may be configured to extend laterally from the main body, effectively increasing the display or preparation area when required. When not in use, the platform may retract seamlessly to maintain the cart's compact profile. In some embodiments, multiple extendable platforms may be present on opposite sides of the main body, offering balanced expansion and accommodating multiple products or activities simultaneously. These platforms may be particularly useful during live demonstrations, tasting events, or when additional workspace is needed for product preparation.

Mobility of the assembly may be achieved through a set of wheels mounted on the bottom surface of the main body. These wheels may be selected for their durability and smooth operation, allowing staff to maneuver the cart across different floor surfaces. Locking mechanisms on the wheels may maintain stability when the cart is stationed, preventing unintended movement and improving safety. The mobility feature may support dynamic retail environments where layout adjustments are frequent and responsiveness to customer flow is required.

The assembly may also include a cover or enclosure mechanism that selectively seals the cavity within the main body. This cover may serve multiple purposes: it may protect the contents from dust, contaminants, or tampering during non-operational hours; it may maintain hygiene standards when the cart is used for food-related purposes; and it may provide an additional surface for branding or promotional messaging when closed. The cover may be configured as a roll-top, sliding panels, or hinged doors, depending on aesthetic preferences and functional requirements.

To further increase versatility, the assembly may incorporate adjustable shelf extenders and modular components. Shelf extenders may be attached to the existing shelves or platforms, providing additional space or creating customized display configurations. Modular components, such as interchangeable panels or accessory mounts, may allow retailers to tailor the cart to specific events, themes, or product lines.

The support structure for the signage assembly may not limited to telescopic adjustments but may also include articulating arms or swivel mechanisms. These features may enable positioning of the signage for optimal visibility, regardless of the cart's location within the store. Integrated lighting solutions, such as LED strips or spotlights, may be added to the support structure or signage assembly to illuminate products and attract customer attention, especially in dimly lit areas or during evening hours.

The assembly may be equipped with power sources or charging stations. Built-in batteries or connections to external power supplies may enable the operation of electronic devices, digital signage, or interactive kiosks. This capability may support activities such as cooking demonstrations using electric appliances, charging customer devices, or powering augmented reality experiences.

The assembly's design may also consider ergonomic factors to ensure ease of use for retail staff. Handles or grips may be integrated into the main body to facilitate pushing or pulling the cart. The height and depth of shelves, drawers, and platforms may be optimized to minimize strain during loading and unloading. Non-slip surfaces on the top and extendable platforms may increase safety when handling products, especially in environments where spills or moisture are possible.

Aesthetically, the cart may be designed to complement the retail environment while providing branding opportunities. The metal alloy construction may offer a sleek and modern appearance, which may be customized with finishes such as powder coating in brand colors, vinyl wraps with graphics, or laser-etched logos. These customization options may allow the assembly to serve not only as a functional tool but also as a visual extension of the retailer's brand identity.

In addition to retail grocery stores, the assembly may be adaptable for use in a variety of settings, including but not limited to, trade shows, outdoor markets, pop-up shops, hospitality events, and educational demonstrations. Its modular and customizable nature may make it suitable for exhibitors who require a portable yet impactful display solution that may be tailored to different venues and audiences.

The assembly may also integrate smart technologies, such as sensors and connectivity features, to increase operational efficiency. For example, weight sensors on the shelves may monitor inventory levels, triggering alerts when restocking is needed. Bluetooth or Wi-Fi connectivity may enable synchronization with inventory management systems, providing real-time data on product movement and customer interactions. These technological integrations may support data-driven decision-making and streamline retail operations.

Environmental considerations may also be addressed in the assembly's design. Materials selected for construction may include recyclable metals and sustainably sourced components. Energy-efficient lighting and electronic elements may reduce the environmental effect, aligning with corporate sustainability initiatives and customer expectations for environmentally responsible practices.

Safety features may be incorporated throughout the assembly to maintain compliance with regulatory standards and to safeguard both staff and customers. Rounded edges, secure locking mechanisms, and stable construction may minimize the probability of accidents. Fire-retardant materials may be used where appropriate, and the assembly may be further configured to meet specific industry safety certifications.

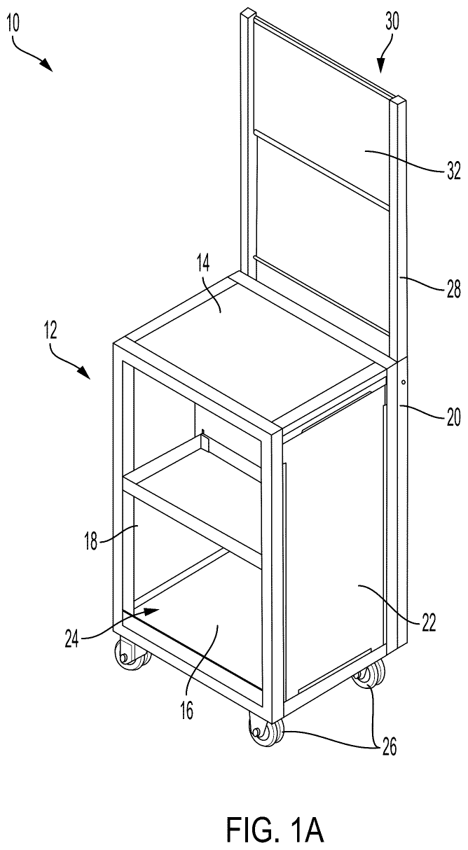

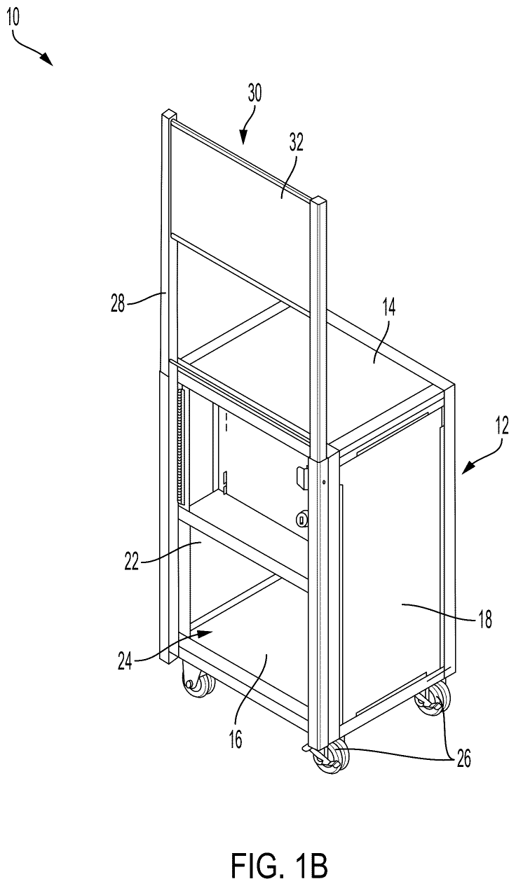

FIGS. 1-4 show a display cart assembly 10. FIGS. 1A and 1B show perspective views of the display cart assembly 10 according to one embodiment. The display cart assembly 10 includes a main body 12 having a top surface 14 configured to receive items for display, a bottom surface 16, and three side surfaces 18, 20, 22 that together define an internal cavity 24. The main body 12 is supported by a set of wheel assemblies 26 mounted to the bottom surface 16 for mobility. A telescopic support 28 extends vertically from the main body 12 and supports adjustable signage assembly 30 above the top surface 14. The signage assembly 30 may be configured as a digital signage assembly with a digital display panel 32 that may be updated remotely, or may be interchangeable. The main body 12 may be constructed from a metal alloy and may also be powder coated.

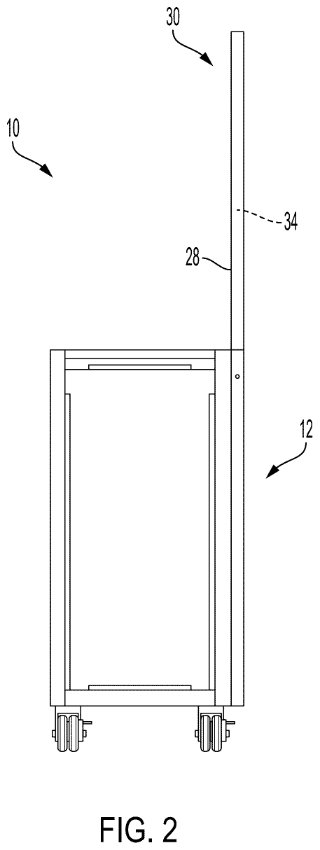

FIG. 2 is a side view of the display cart assembly 10, showing the profile of the telescopic support 28 extending upward from the main body 12. FIG. 2 shows the vertical adjustability of the telescopic support 28, which may incorporate adjustment mechanisms 34 that allow the height of the signage assembly 30 to be modified as needed.

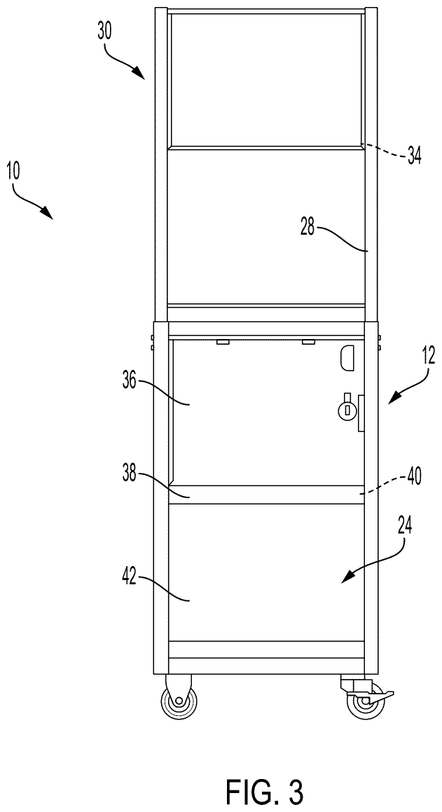

FIG. 3 shows a rear view of the display cart assembly 10 and the organization of internal components within the main body 12. An access panel 36 and least one shelf 38 is situated within the internal cavity 24. The shelf 38 may be adjustable in height using mounting points 40. A cover 42, may be provided to selectively enclose the internal cavity 24 defined by the main body 12.

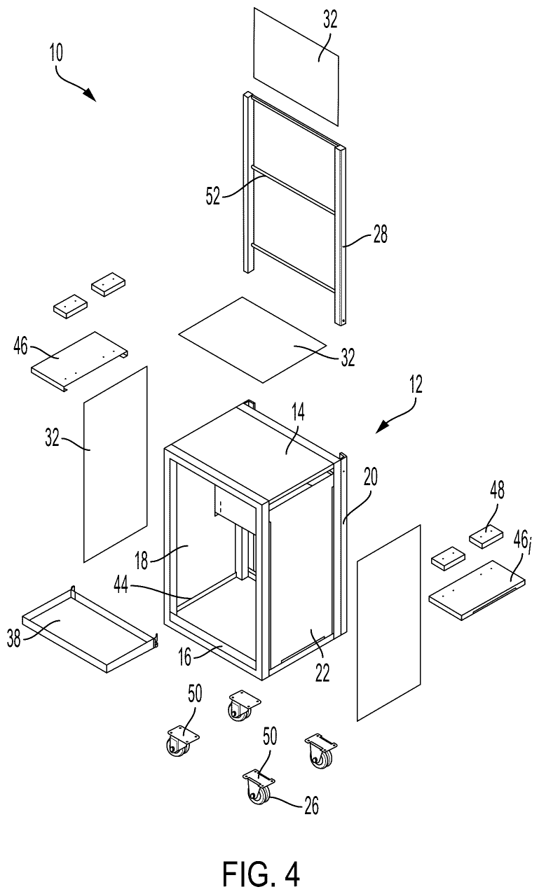

FIG. 4 is an exploded view of the display cart assembly 10, showing the relationship between its various components. The main body 12 includes mounting channels 44 for securing the side surfaces 18, 20, 22. The side surfaces 18, 20, 22 may be welded or otherwise fastened to the main body 12 via the mounting channels 44. The top surface 14 includes at least one extendable platform 46 that may be selectively extended between a stored position coplanar with the top surface 14 and an open position extending laterally from the top surface 14. The assembly may include two extendable platforms 46, 46i, each arranged at opposite side surfaces of the main body 12. The two extendable platforms 46, 46; may include support brackets 48 to facilitate the extension of the two extendable platforms 46, 46; the main body 12. The wheel assemblies 26 may attach to mounting plates 50 on the bottom surface 16. The signage assembly 30 may connect to the telescopic support 28 through an adjustable bracket 52 that allows for positioning of the display panel 32. The display panel 32 may also be incorporated into side surfaces 18, 20 and top surface 14.

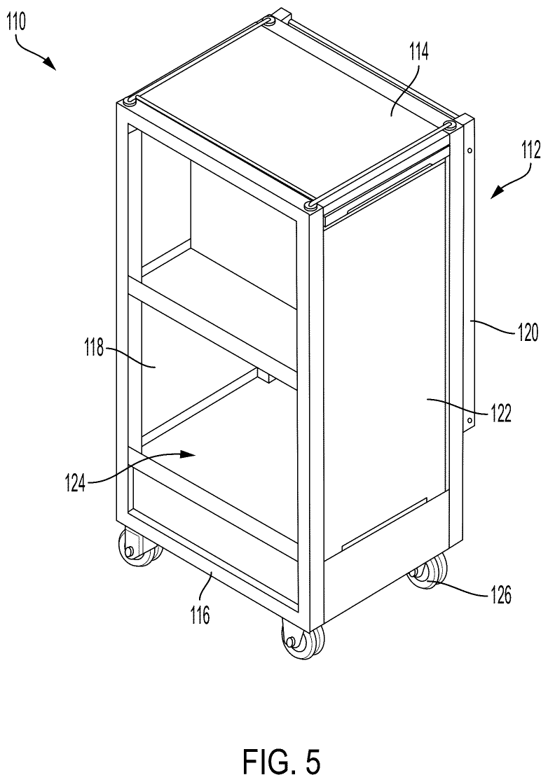

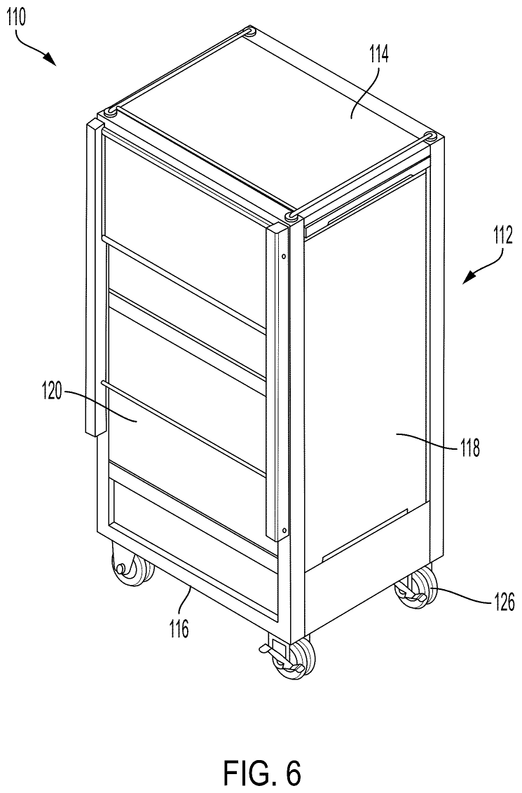

FIGS. 5-8 show perspective views of an alternative embodiment of a display cart assembly 110. The assembly 110 includes a main body 112 with top surface 114, bottom surface 116, and three side surfaces 118, 120, 122 defining an internal cavity 124. In this embodiment, the main body 112 is supported by wheels 126 mounted to the bottom surface 116.

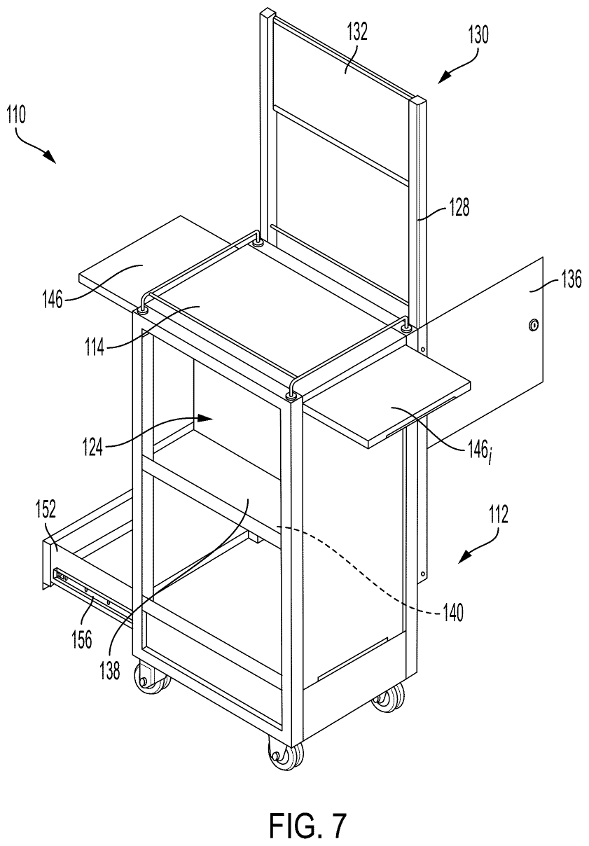

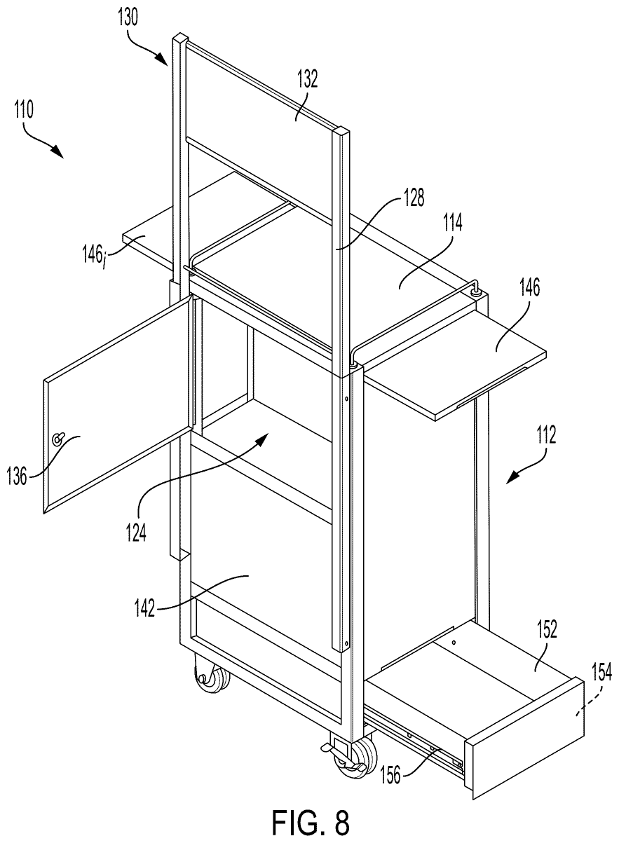

FIGS. 7 and 8 show the assembly 110 with its functional components in deployed positions. The telescopic support 128 extends vertically from the main body 112 to hold the signage assembly 130 with its display panel 132. FIGS. 7 and 8 show the extendable platforms 146, 146; in their open positions, extending laterally from opposite sides of the top surface 114. The extendable platforms 146, 146; may be selectively extended between their stored position, where they remain coplanar with the top surface 114, and their open position, where they extend laterally to provide additional display or work space.

FIG. 8 further shows a drawer assembly 152 in its extended position protruding from the internal cavity 124. The drawer assembly 152 includes a locking mechanism 154, ensuring secure storage when needed. The internal cavity 124 is shown with the adjustable shelf 138 engaged with mounting points 140 for height adjustability. The drawer assembly 152 may incorporate guide rails 156 that facilitate smooth movement between stored and extended positions of the drawer assembly 152. The side surfaces of the main body 112 may further include an access panel 136 that may be opened to provide additional access to the internal cavity 124, working in conjunction with the cover 142 to provide selective access to the storage space.

The accompanying figures are not necessarily drawn to scale. Instead, emphasis has been placed upon clearly illustrating the components and principles of the invention. Certain dimensions or proportions may be exaggerated or minimized to convey the essence of the invention effectively. As such, the specific structural and functional details disclosed herein are not to be interpreted as limiting but merely as a representative basis for teaching one skilled in the art to variously employ the present invention. The figures and descriptions are intended to be illustrative and are not meant to restrict the scope of the invention.

It should be appreciated that while the present invention has been described in connection with particular embodiments, the invention as claimed is not limited to those embodiments. On the contrary, the invention includes all alternatives, modifications, and equivalents that may be included within the spirit and scope of the invention as defined by the claims. Features described in relation to one embodiment may be incorporated into other embodiments even if not specifically described relative thereto, provided that such incorporation does not contradict or undermine the functionality of the other embodiments.

The terminology used herein is for the purpose of describing particular embodiments only and is not intended to limit the invention. As used herein, the singular forms “a,” “an,” and “the” are intended to include the plural forms as well, unless the context clearly indicates otherwise. Similarly, the terms “comprises,” “comprising,” “includes,” and “including” are intended to be open-ended, specifying the presence of stated features but not precluding the presence or addition of other features, components, or groups thereof.

It is understood that the invention is not limited to the precise arrangements and instrumentalities shown and described herein. Modifications and adaptations of the invention will occur to those skilled in the art without departing from the spirit and scope of the invention. Therefore, it is intended that the appended claims cover all such modifications and adaptations that are within the scope of the invention.

Additionally, the features of various implementing embodiments may be combined to form further embodiments of the invention. Combinations of features from different embodiments are considered within the scope of the invention, provided they do not render the combination inoperable or inconsistent. The disclosure of individual elements in the various embodiments is not intended to be an indication of a required combination of elements unless explicitly stated.

The present invention has been described with reference to specific embodiments, which are illustrative and not intended to be limiting. The scope of the invention is defined by the appended claims rather than the foregoing description. All equivalents, modifications, and variations falling within the spirit and broad scope of the claims are therefore to be embraced by the invention.

What is claimed is:

1. An assembly comprising:
a main body including a top surface, a bottom surface, and three side surfaces defining a cavity within the main body, wherein the top surface is configured to receive items for display;
at least one shelf situated within the cavity of the main body;
at least one support extendable in an upright direction from the main body; and
a signage assembly held by and adjustable above the main body held via the support.

2. The assembly of claim 1 wherein at least one of the side surfaces defines a drawer opening configured to receive a drawer therethrough, the drawer configured to extend between a stored position within the cavity and an extended position at least partially outside of the cavity.

3. The assembly of claim 2 wherein the drawer includes a locking mechanism.

4. The assembly of claim 1 wherein the main body is constructed from a metal alloy.

5. The assembly of claim 1 wherein the main body is powder coated.

6. The assembly of claim 1 wherein the at least one support is telescopic for adjusting the height of the signage assembly.

7. The assembly of claim 1 wherein the signage assembly is a digital signage assembly.

8. The assembly of claim 7 wherein the signage assembly includes a digital display configured to be updated remotely.

9. The assembly of claim 1 wherein the signage assembly is interchangeable.

10. The assembly of claim 1 wherein the shelf is adjustable in height within the cavity.

11. The assembly of claim 1, further comprising a set of wheels mounted on the bottom surface of the main body.

12. The assembly of claim 1, further comprising a cover to selectively enclose the cavity defined by the main body.

13. An assembly comprising:
a main body including a top surface, a bottom surface, and three side surfaces defining a cavity within the main body, wherein the top surface includes at least one extendable platform selectively extendable between a stored position coplanar with the top surface and an open position extending laterally from the top surface;
at least one shelf situated within the cavity of the main body;
a support extendable in an upright direction from the main body; and
a signage assembly adjustable above the main body held by the support.

14. The assembly of claim 13 wherein the at least one extendable platform includes two extendable platforms, each arranged at opposite side surfaces of the main body.

15. The assembly of claim 13 wherein the shelf is adjustable in height within the cavity.

16. The assembly of claim 13 wherein the support is telescopic.

17. The assembly of claim 13 wherein the signage assembly is digital signage.

18. The assembly of claim 13, wherein at least one of the side surfaces defines an opening configured to receive a drawer therethrough, the drawer configured to extend between a stored position within the cavity and an extended position at least partially outside of the cavity.

19. The assembly of claim 18 wherein the drawer includes a locking mechanism.

20. An assembly comprising:
a main body including:
a top surface configured to receive items for display and including at least one extendable platform selectively extendable between a stored position coplanar with the top surface and an open position extending laterally from the top surface;
a bottom surface; and
three side surfaces defining a cavity within the main body, wherein at least one of the side surfaces defines a drawer opening configured to receive a drawer therethrough;
at least one shelf adjustable in height situated within the cavity of the main body;
a telescopic support extendable in an upright direction from the main body;
an adjustable signage assembly above the main body held by the telescopic support;
a drawer including a locking mechanism and configured to extend between a stored position within the cavity and an extended position at least partially outside of the cavity;
a set of wheels mounted on the bottom surface of the main body for mobility; and
a cover to selectively enclose the cavity defined by the main body.
